(19) United States
(12) Patent Application Publication
(10) Pub. No.: US 2007/0183417 A1
(43) Pub. Date: Aug. 9, 2007

(54) Data traffic router

(76) Inventor: Joel J. Maleport, O'Fallon, MO (US)

Correspondence Address: JOHN S. BEULICK (24691);ARMSTRONG TEASDALE LLP, ONE METROPOLITAN SQUARE, SUITE 2600, ST. LOUIS, MO, 63102-2740, US

(21) Appl. No.: 11/350,990

(22) Filed: Feb. 9, 2006

(51) Int. Cl. H04Q 7/00; H04L 12/56; H04J 3/16

(52) U.S. Cl. 370/389; 370/466; 370/400; 370/328

(57) ABSTRACT

Systems and methods are disclosed for routing data traffic along a specific route. The method is implemented by a data traffic router configured within a networked environment to appear as a standard network router that caused data to be transmitted through a prescribed data path. The disclosed systems and methods may include routing the data from the source to a first router by manipulating a frame header, and routing the data from the first router to a second router by manipulating the frame header. Furthermore, the disclosed systems and methods associate a first packet header with a second packet header, which contains an address associated with the destination. The system and method route the data from the second router to the third router using the first packet header, wherein the first packet header contains an address associated with hardware within the prescribed datapath. Finally, the systems and methods route the data to the destination using the second packet header.

### BACKGROUND

I. Field of the Invention

The present invention generally relates to methods and systems for routing data traffic along a specific route. More particularly, the present invention relates to a data traffic router configured within a networked environment to appear as a standard network router that, for example, causes data to be transmitted through a prescribed data path.

II. Background Information

Internet Protocol (IP) networks have been designed to route traffic using the most efficient path available. In some situations, hardware components used in transmitting data from a source to a destination over a network need to be tested to ensure proper operation. However, instances may occur in which not all hardware components reside within the same data traffic area network (LAN), wide area network (WAN), or location in general. Thus, testing the hardware components is difficult because normal data transmissions occur using the shortest or most efficient route and may not use the hardware component desired to be tested. In order to perform testing on designated equipment, the data traffic must follow a specific route.

A conventional strategy used to route data traffic along a specific path is modify a host application (an application which supplies test data) in order to establish a connection with a remote system housing the hardware components desired to be tested. Another conventional strategy forces network administrators to modify each router in a network thereby causing the data to follow a desired path. These strategies often are problematic because they require an in depth knowledge of data routing within the network, and require considerable time altering network hardware for each test.

In addition, it can be very time consuming, costly, and error prone to redesign software and reconfigure network devices to force traffic to follow a path other than the preferred path. There is a need for a system that minimizes the impact on the network and application software, requiring no custom network configuration.

### SUMMARY

Consistent with embodiments of the present invention, systems and methods are disclosed for a data traffic router. In accordance with one embodiment, a method for routing data from a source to a destination according to a prescribed datapath comprising routing the data from the source to a first router by manipulating a frame header, routing the data from the first router to a second router by manipulating the frame header, associating a first packet header with a second packet header used to route the data from the second router to a third router, wherein the second packet header contains an address associated with the destination, routing the data from the second router to the third router using the first packet header, wherein the first packet header contains an address associated with hardware within the prescribed datapath, disassociating the first packet header from the second packet header used to route the data from the second router to a third router, and routing the data to the destination using the second packet header.

According to another embodiment, computer-readable medium which stores a set of instructions which when executed performs a method for routing data from a source to a destination according to a prescribed datapath, the method executed by the set of instructions comprising routing the data from the source to a first router by manipulating a frame header, routing the data from the first router to a second router by manipulating the frame header, associating a first packet header with a second packet header used to route the data from the second router to a third router, wherein the second packet header contains an address associated with the destination, routing the data from the second router to the third router using the first packet header, wherein the first packet header contains an address associated with hardware within the prescribed datapath, disassociating the first packet header from the second packet header used to route the data from the second router to a third router, and routing the data to the destination using the second packet header.

In accordance with yet another embodiment, a system for routing data from a source to a destination according to a prescribed datapath, comprising a first data router, a second router and a third router. The first router is configured to receive a data packet from the source and route the data packet to the second router. The data packet routed by the first router to the second router includes a first header and a second header that are associated. The first header of the data packet routes the data packet to a location along the prescribed data path. The second header of the data packet contains original IP header information, which directs the data packet to its final destination. The second router routes the data packet to a third router using the first header of the packet that contains an address associated with hardware along the prescribed data path. The data packet travels through a plurality of hardware devices along the prescribed data path and is finally transmitted to the final destination upon a hardware device reading the information in the second header.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a diagram illustrating an exemplary system architecture for routing data from a source to a destination according to a prescribed datapath, according to one embodiment.

FIG. 2 is an illustration of a packet of data including an Ethernet Frame header, an IP header and data, according to one embodiment;

FIG. 3 is an illustration of a packet of data including an Ethernet Frame header, a tunneling IP header, an original IP header and data, according to one embodiment;

FIG. 4 is an illustration of a packet of data including an Ethernet Frame header, a tunneling IP header, an original IP header and data, according to one embodiment;

FIG. 5 is an illustration of a packet of data including an Ethernet Frame header, an IP header and data, according to one embodiment;

FIG. 6 is an illustration of a packet of data including an RF header, an original IP header and data, according to one embodiment; and

FIG. 7 is an illustration of a packet of data including an Ethernet Frame header, an IP header and data, according to one embodiment.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding stages to the disclosed methods. Accordingly, the following detailed description does not limit the invention. Instead, the proper scope of the invention is defined by the appended claims.

The data traffic router implements systems and methods that facilitate the routing of data traffic along a prescribed data path. This is a preferred method used to test desired hardware components within a networked environment. The system uses a data traffic router connected to a source to insert a tunneling Internet Protocol (IP) header onto each data packet of interest in order to force other routers in a network to send the data traffic through the prescribed path (i.e., tunneling-embedding IP Packet header information into a message while maintaining the original IP Packet header information from the original message). At an intermediate destination, a second data traffic router connected to the intermediate destination removes the tunneling IP header prior to sending the data to an additional destination.

A data traffic router appears as a standard network router to any system on the network. However, it utilizes tunneling to ensure that the data traffic follows a prescribed path. Since the data traffic router is a separate piece of hardware, it can support tunneling of a network's data traffic using many network hardware configurations or software architectures. Because the data traffic router uses tunneling, systems on the network operate as though the data traffic router is not connected (transparent). Thus, the data traffic router facilitates the routing of data traffic along a prescribed path without having to reconfigure routers in the network, and without having to either install or modify software on a source application system that is generating the network traffic. Additionally, the data traffic router may be connected to a network quickly and may be disconnected from a network quickly thereby avoiding the coordination that is typically necessary to reconfigure routers in the network. Accordingly, the data traffic router can allow systems to be tested and integrated faster while incurring a minimal impact on an existing network infrastructure.

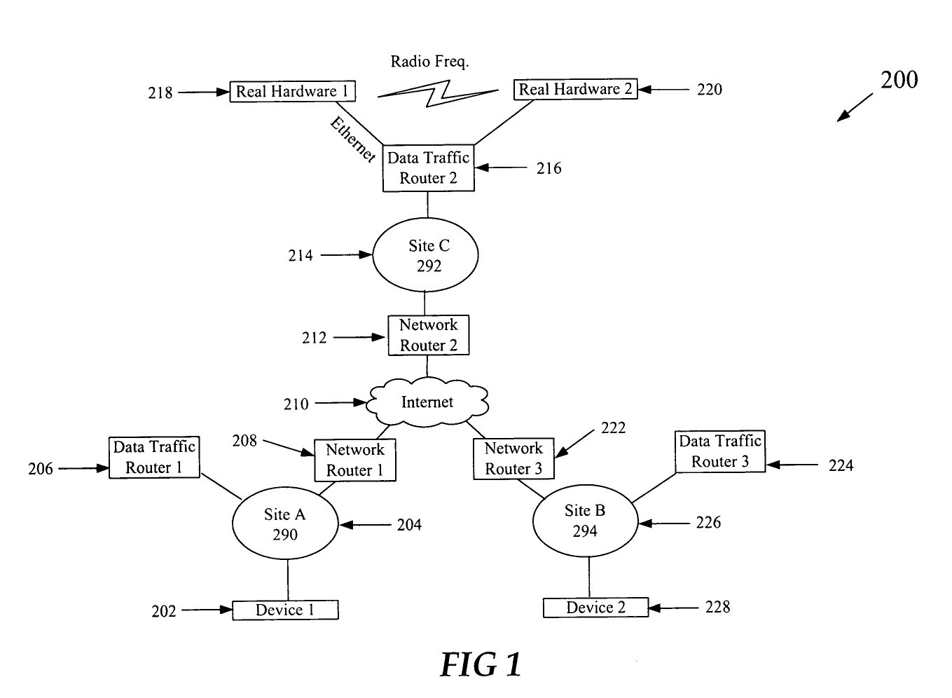

FIG. 1 is a diagram illustrating exemplary system architecture 200 that facilitates the routing of data from a source to a destination according to a prescribed data path, according to one embodiment of the present invention. The system architecture 200 illustrates how the data traffic router fits into the architecture illustrated, which includes a first data traffic router 206, a second data traffic router 216 and a third data traffic router 224. As illustrated, the system architecture 200 includes a first device 202 configured to transmit data in accordance with traditional IP protocol. In the present embodiment, first device 202 is a simulator comprising a computer upon which test applications used for testing desired hardware components are stored. The system architecture 200 also includes a first LAN 204, a first network router 208, a communications medium 210, a second network router 212, a second LAN 214, a first hardware device 218, a second hardware device 220, a third network router 222, a third LAN 226, and a second device 228. The second device 228 is configured to receive and transmit data in accordance with traditional IP protocol and in the present embodiment is a simulator comprising a computer upon which test applications used for testing desired hardware components is stored.

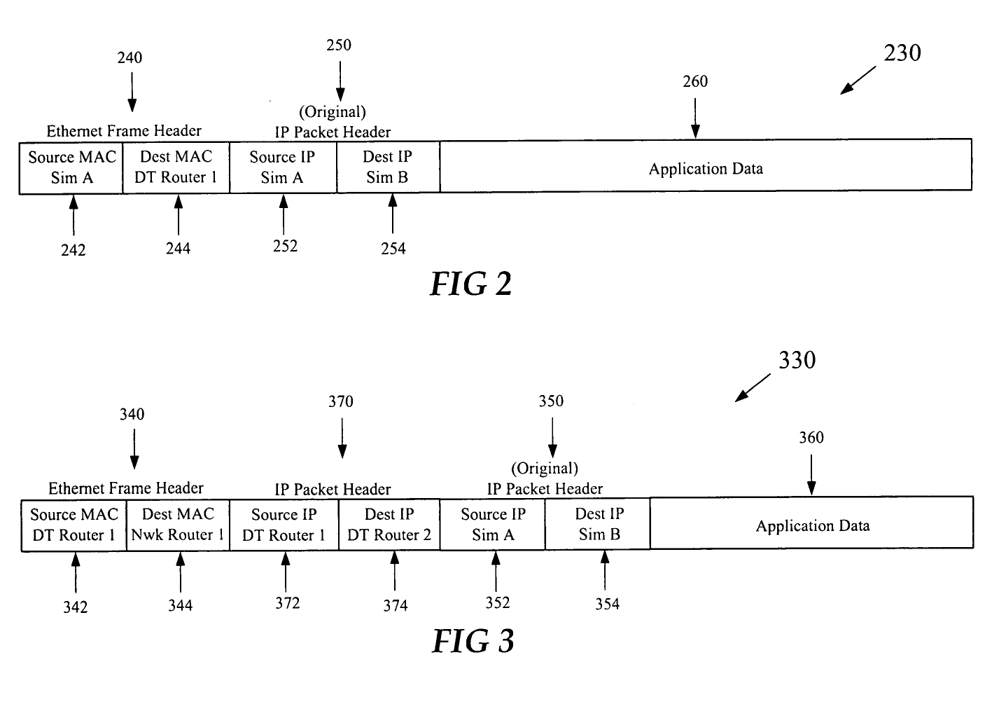

When first device 202 needs to communicate with the second device 228, instead of communicating along the shortest path by transmitting data through the first LAN 204 directly to the first network router 208, through a communications medium 210, such as the Internet, to the third network router 222, through the third LAN 226 to the second device 228, the data traffic router facilitates the communication along an alternative path. In the present embodiment, the alternative path is desirable to test hardware such as first hardware device 218 and second hardware device 220. Transmission of data along the alternative path begins at a first source location 290 (Site A), at which the first device 202, the first data traffic router 206 and the first network router 208 are operatively connected to each other through the first LAN 204. In order to communicate with a destination location 294 (Site B) using the alternative path, a data packet is transmitted along a data path that includes passing data through a first hardware device 218 and a second hardware device 220. In utilizing the alternative path, a tunneling process is used. FIG. 2 illustrates the contents of the data packet during the first phase of transmission of a data packet through the system architecture. Packet 230 is comprised of at least an Ethernet frame header 240, Internet Protocol (IP) header 250 and application data 260.

When the first device 202 attempts to transmit a packet 230 outside of the first LAN 204 to a destination location 292, the first device 202 sends at least the IP header 250 and the application data 260 of packet 230 to the first data traffic router 206 by designating the first data traffic router 206 as a destination media access control (MAC) 244 address and the first device 202 as the source MAC 242. The first device 202 sends the IP header 250 and the data 260 to the first data traffic router 206 by listing the address of the first data traffic router 206 as the destination MAC 244 within an Ethernet frame header 240. Accordingly, the application data 260 of packet 230 which can be sent from first device 202 to the second device 228 may be transmitted from the first device 202 to the first data traffic router 206.

FIG. 2 illustrates the contents of packet 230 during transmission from the first device 202 to the first data traffic router 206. Packet 230 typically contains an Ethernet Frame header 240 that defines the source and destination. As illustrated, the source 242 is defined as first device 202 and the destination 244 is defined as the first data traffic router 206. The Ethernet Frame header 240 is non-routable information (meaning that it is only used on the local LAN and that it is never sent across the internet). The IP header 250 is routable information (meaning that it is used to direct the flow of the packet and its associated data through the network). Thus, each time packet 230 passes through a computer (sometimes called a node when using networking terms), the Ethernet Frame header 240 is updated with new source and destination addresses, but the IP header 250 typically does not change. Finally, the application data 260 is the information being exchanged between two devices in the network.

When the first data traffic router 206 receives a data packet 230 (FIG. 2) from the first device 202 containing the Ethernet frame header 240, the IP header 250 and the application data 260, the first data traffic router 206 proceeds in forwarding a revised packet 230 to the first network router 208. As illustrated in FIG. 3, the revised packet includes an IP header 350, application data 360 and an updated Ethernet Frame Header 340. In order to route the IP packet header 350 and the application data 360 to the first network router 208, the first data traffic router 206 modifies the source MAC 342 and the destination MAC 344 within the Ethernet frame header 340. The first data traffic router 206 can designate the address of the first data traffic router 206 as the source MAC 342 and the address of the first network router 208 as the destination MAC 344. In addition, in order to ensure that the application data 360 follows a prescribed data path, the first data traffic router 206 tunnels the application data out to its destination. Tunneling is the process of embedding one IP packet inside of another. The process of tunneling requires that a new tunneling IP Header 370 be inserted in front of the original IP header as shown in FIG. 3. The tunneling IP header 370 can designate the first data traffic router 206 as a source IP address 372 and the second data traffic router 216 as a destination IP address 374, thereby forcing the original IP packet header 350 and the application data 360 to follow a desired data path through a third LAN 214. Note that there are now two IP headers 350 and 370. One IP header 370 is used for tunneling and a second IP header 350 originated from the first device 202. The first data traffic router 206 inserts the tunneling IP header 370 in front of the original IP header 350 because the network routers within the system expect the IP header to be in a very specific location. Therefore, the original IP header 350 is moved to the right so that the data traffic router 206 may insert the tunneling IP header 370 that controls the path that packet 330 will take through the network 210. It is also important to note that all of the original data 360 is kept intact and no modifications have been made to any of the application data. By doing this, applications may communicate over any port without having to modify the original application. This facilitates a zero code impact to the original application.

In comparing the packet 230 shown in FIG. 2 to the packet 330 shown in FIG. 3, the changes to the Ethernet Frame header 240 are illustrated. It can be seen that the Ethernet Frame source 242 and destination 244 addresses have changed. In FIG. 2, the information was being sent from the first device 202 to the first data traffic router 206. In FIG. 3, the information is being sent from the first data traffic router 206 to the network router 208. In addition, the new tunneling IP header 370 has been added. A tunneling IP header 370 has the exact same format as the original IP header 350 with the exception that the source and destination IP addresses have been modified.

By adding the tunneling IP packet header 370, the original IP packet header 350 and the application data 360 are sent to a site on the network designated by the destination IP address within the tunneling IP packet header 370 which may not follow the most efficient routing of data traffic. Thus, the inclusion of the tunneling IP packet header 370 facilitates the testing of desired hardware components, such as hardware components 218 and 220, when such hardware components are located at remote sites. In the embodiment illustrated in FIG. 1, site C 292 is located remote to site A 290 and site B 294, and does not reside in the most direct or efficient data path between site A 290 and site B 294.

When the first network router 208 receives the packet 330, illustrated in FIG. 3, from the first data traffic router 206, the first network router 208 forwards the original IP packet header 350 and the application data 360 to the second data traffic router 216, using the tunneling IP packet header 370. Inclusion of the tunneling IP header 370 into the data packet 330 by the first data traffic router 206 alters the transmission path of the packet from the first device 202. The first network router 208 utilizes the destination IP address of the tunneling IP packet header 370, which has the second data traffic router 216 as the destination IP address 374 instead of the original destination IP 354, which has the second device 228 as the destination IP. Thus, the first network router 208 sends the original IP header 350 and the application data 360 to the second data traffic router 216 using the communications medium 210 and the second network router 212 and the second LAN 214. In the embodiment illustrated in FIG. 1, the communications medium 210 is the Internet. However it is contemplated that communications medium 210 may be a virtual private network, or a wide area network connection so long communications medium 210 facilitates the connection of remote devices on remote LAN networks.

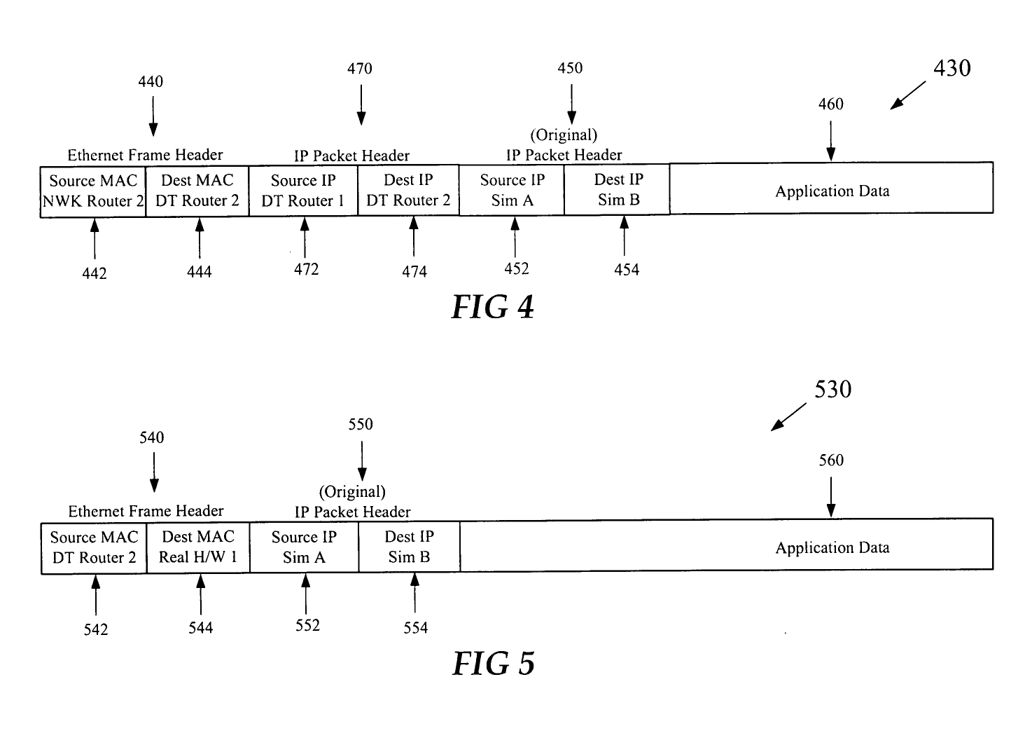

When packet 330, illustrated in FIG. 3, is received at the second network router 212, the second network router 212 modifies data packet 330 to packet 430 illustrated in FIG. 4 and transmits data packet 430 through the second LAN 214 utilizing the Ethernet frame header 440 which has been updated to designate the second network router 212 as the source MAC 442 and second data traffic router 216 as the destination MAC 444. The Ethernet frame header is updated by the second network router 212 to forward the IP packet header 450 and the application data 460 to the second data traffic router 216. While the IP packet header 450 and the application data 460 sent from the simulator 202 are sent to an intermediate location (site C) 294 before being received at the destination location (site B) 292, the IP header 250 and the application data 260 remain unchanged.

When the second data traffic router 216 receives a packet 430 from the second network router 212 containing the Ethernet frame header 440, the IP packet header 470, the IP packet header 450 and the data 460, the second data traffic router 216 proceeds removes the tunneling IP header 470 before forwarding the IP packet header 450 and the application data 460 to the hardware component 218, thereby terminating the tunneling process and allowing the normal routing process to continue unabated.

When the second data traffic router 216 receives packet 430 that includes the Ethernet frame header 440, the IP packet header 470, the IP packet header 450 and the application data 460, it revises the packet 430 to packet 530 illustrated in FIG. 5. As illustrated in FIG. 5, packet 530 includes an Ethernet frame header 540 that designates the second data traffic router 216 as the source MAC 542 and first hardware component 218 as the destination MAC 544. The data within the original IP header 550 and the application data have remained unchanged. Designating the second data traffic router 216 as the source MAC 542 and the hardware component 218 as the destination MAC 544 sends the IP packet header 550 and the application data 560 to the hardware component 218.

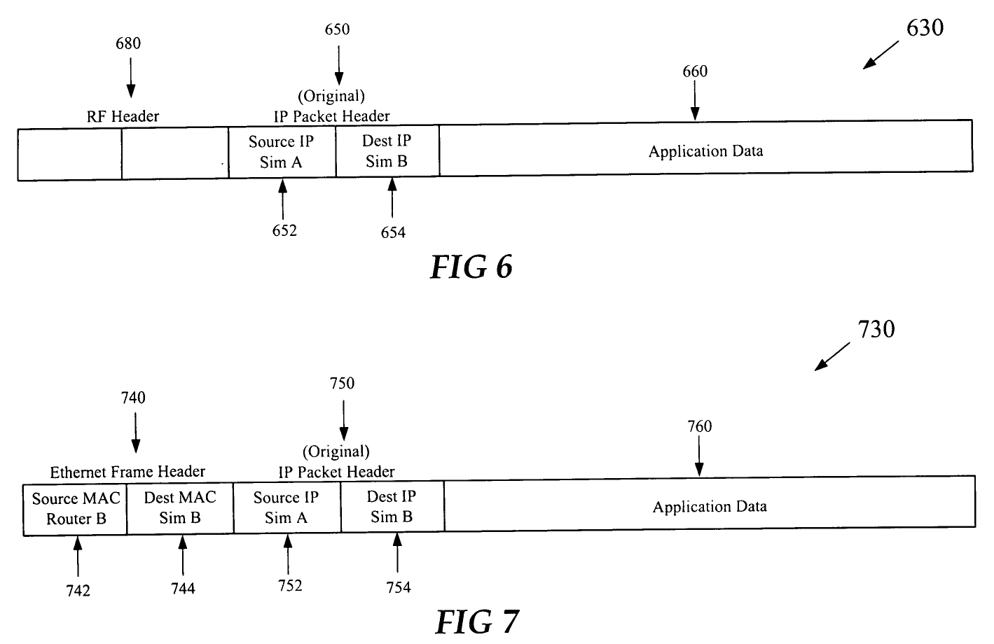

In the present embodiment, the first and second hardware devices 218 and 220 communicate wirelessly using radio frequency. As packet 630 of FIG. 6 illustrates, no knowledge of how the first and second hardware devices 218 and 220 route data is assumed. Packet 630 includes an RF header 680, an IP header 650 and application data 660. The RF header 680 is illustrated as an undefined entity because the format is contingent upon the first and second hardware devices 218 and 220 and the RF waveform they employ.

When the IP packet header 650 and the data 660 are received by the hardware component 220, the hardware component 220 forwards the IP packet header 650 and the data 660 to the simulator 228 using an Ethernet connection to transmit the IP packet header 650 and the data 660 to the second data traffic router 216 which may subsequently forward the IP header 650 and the data 660 to the second LAN 214 using an Ethernet connection.

When the second data traffic router 216 receives a packet 630 from the hardware component 220, it proceeds in forwarding a revised packet 730 to the second network router 212 through the second LAN 214. The revised packet 730 includes an Ethernet frame header 740, the IP packet header 750 and the application data 460. The LAN 214 can forward the IP packet header 750 and the application data 760 through second network router 212 to third network router 222 using the Internet and IP packet header 750. Since the second network router 222 can be connected to a third LAN 226 using an Ethernet connection, the Ethernet frame header 740 can be used to send the data 760 to its original destination, the second device 228. Because the system architecture 200 has tested the desired hardware components, hardware component 218 and hardware component 220, data 260 can be transmitted from site C 294 to site B 292 using normal routing techniques.

Because the system architecture 200 utilizes tunneling, a message sent from the simulator 202 to the simulator 228 can be transmitted along a prescribed route in order to test desired hardware components (hardware component 218 and hardware component 220) to evaluate operations of the hardware components as well as software operating with the system architecture 200. Thus, remote systems can be tied together in a network centric environment without requiring the systems to be collocated at a common facility. In addition, because the remote systems can be tied together using the system architecture 200, product testing may be conducted faster and more efficiently because an in depth knowledge of data routing within the network and alteration of the network is not required. Accordingly, engineers and product designers can identify issues sooner in the development process because the system architecture 200 can allow for more frequent integration testing.

The invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering stages and/or inserting or deleting stages, without departing from the principles of the invention.

It is intended, therefore, that the specification and examples be considered as exemplary only, with a true scope and spirit of the invention being indicated by the following claims and their full scope of equivalents.

What is claimed is:

1. A method for routing data from a source along a prescribed datapath, the method comprising:
manipulating a frame header wherein said frame header routes data from the source to a first router;
modifying said frame header to route data from said first router to a second router;
generating a first packet header;
associating said first packet header with a second packet header;
routing the data from said second router to a third router using said first packet header, wherein said first packet header contains an address associated with a destination along the prescribed data path;
disassociating the first packet header from the second packet header used to route the data from the second router to a third router; and
routing the data to a second destination along the prescribed data path using the second packet header.

2. The method of claim 1, wherein the prescribed datapath is not a shortest data path for sending the data from the source to a second destination.

3. The method of claim 2, wherein said second destination is located at a location remote to the source.

4. The method of claim 1, wherein associating a first packet header with a second packet header is used to perform a tunneling function.

5. The method of claim 1, wherein the second packet header contains original IP packet header information associated with a second destination of the data.

6. The method of claim 1, wherein the source, the first router and the second router are connected through a LAN.

7. The method of claim 1, wherein the second router and the third router are connected through the Internet.

8. The method of claim 1, wherein the data is routed from the source to the destination using a radio frequency.

9. The method of claim 1 wherein said destination along the prescribed data path is located at a location remote to the source.

10. The method of claim 1, wherein the routing data from a source to a second destination along a prescribed data path tests hardware components along the prescribed data path.

11. The method of claim 10, wherein the first packet header routes the data to a location housing hardware components.

12. A computer-readable medium which stores a set of instructions which when executed performs a method for routing data from a source to a final destination according to a prescribed datapath, the method executed by the set of instructions comprising:
manipulating a frame header wherein said frame header routes data from the source to a first router; modifying said frame header to route data from said first router to a second router;
generating a first packet header;
associating said first packet header with a second packet header;
routing the data from said second router to a third router using said first packet header, wherein said first packet header contains an address associated with a destination along the prescribed data path;
disassociating the first packet header from the second packet header used to route the data from the second router to a third router; and
routing the data to a second destination along the prescribed data path using the second packet header.

13. The computer readable storage medium of claim 12, wherein associating a first packet header is used to perform a tunneling function.

14. The computer readable storage medium of claim 12, wherein the second packet header contains original IP packet header information associated with the final destination of the data.

15. The computer readable storage medium of claim 12, wherein the routing data from a source to the final destination according to a prescribed datapath tests hardware components along the prescribed data path.

16. The computer readable storage medium of claim 15, wherein the first packet header routes the data to a location housing the hardware components.

17. A system for routing data from a source to a destination according to a prescribed datapath, the system comprising:
a first router configured to receive the data from the source and route the data to a second router;
wherein the data with the second router includes a first packet header and a second packet header and said first packet header is associated with said second packet header;
wherein the data within the second router is routed to a third router using the first packet header, wherein the first packet header contains an address associated with hardware within the prescribed data path; and
wherein the data within the second router is routed to the destination using the second packet header.

18. The system of claim 17, wherein associating a first packet header with a second packet header used to route the data from the second router to a third router is used to perform a tunneling function.

19. The system of claim 17, wherein the second packet header contains original IP packet header information associated with the destination of the data.

20. The system of claim 17, wherein the first packet header routes the data to a location housing hardware components within the prescribed data path.
